(19) United States
(12) Patent Application Publication
(10) Pub. No.: US 2026/0252799 A1
(43) Pub. Date: Aug. 27, 2026

(54) INFORMATION PROCESSING SYSTEM, INFORMATION PROCESSING METHOD, AND RECORDING MEDIUM

(71) Applicant: NEC Platforms, Ltd., Kanagawa (JP)

(72) Inventor: Kanade EDO, Kanagawa (JP)

(73) Assignee: NEC Platforms, Ltd., Kanagawa (JP)

(21) Appl. No.: 19/161,755

(22) PCT Filed: Mar. 11, 2024
(86) PCT No.: PCT/JP2024/009359

§ 371 Date: Sep. 3, 2025

(30) Foreign Application Priority Data
Mar. 15, 2023 (JP) 2023-040780

(51) Int. Cl. G06F 40/289; G06F 40/40; G06Q 30/0203

(52) U.S. Cl. CPC G06F 40/289; G06F 40/40; G06Q 30/0203

(57) ABSTRACT

This information processing system processes information on a questionnaire answer including a text of free description format with regard to a subject of a survey. The information processing system extracts one or more characteristic phrases related to a negative evaluation with respect to the subject of the survey from the text, and presents a message related to the extracted characteristic phrases.

### TECHNICAL FIELD

The present disclosure relates to an information processing system, an information processing method, and a recording medium.

### BACKGROUND ART

A technique for analyzing questionnaire results including answers in a free description format has been proposed.

For example, a questionnaire result display system described in PTL 1 analyzes a questionnaire answer including factor item evaluation selected from options and a detailed factor in a free description format indicating a reason for selecting the factor item evaluation.

### CITATION LIST

### Patent Literature

PTL 1: JP 2020-149348 A

### SUMMARY OF INVENTION

### Technical Problem

However, the questionnaire result display system described in PTL 1 simply classifies the content of the detailed factor answered in the free description format into any of a plurality of preset detailed factor items. Therefore, in a case where a phrase that is not assumed as the detailed factor item is included in the answer in the free description format, the phrase is not reflected in an analysis result to be presented to a questioner. Then, the output result of the questionnaire result display system cannot sufficiently reflect the questionnaire answer in the free description format. Therefore, there is room for improving the accuracy of the content of the output based on the questionnaire answer in the free description format.

Therefore, an object of the present disclosure is to provide an information processing system, an information processing method, and a recording medium that solve the above-described problem.

### Solution to Problem

According to a first aspect of the present disclosure, there is provided an information processing system that processes information of a questionnaire answer including a text in a free description format regarding a subject to be surveyed, the information processing system including: characteristic phrase extraction means for extracting, from the text, one or more characteristic phrases related to a negative evaluation of the subject to be surveyed; and message means for presenting a message related to the extracted one or more characteristic phrases.

According to a second aspect of the present disclosure, there is provided an information processing method executed by a computer, the method including: extracting, from a text that is included in a questionnaire answer and is in a free description format regarding a subject to be surveyed, one or more characteristic phrases related to a negative evaluation of the subject to be surveyed; and presenting a message related to the extracted one or more characteristic phrases.

According to a third aspect of the present disclosure, there is provided a recording medium storing a program for causing a computer to execute: extracting, from a text that is included in a questionnaire answer and is in a free description format regarding a subject to be surveyed, one or more characteristic phrases related to a negative evaluation of the subject to be surveyed; and presenting a message related to the extracted one or more characteristic phrases.

### Advantageous Effects of Invention

According to an example embodiment of the present disclosure, it is possible to improve the accuracy of output contents based on a questionnaire answer in a free description format.

### BRIEF DESCRIPTION OF DRAWINGS

FIG. 1 is a block diagram illustrating an information processing system 100 according to a first example embodiment.

FIG. 2 is a diagram illustrating an outline of message generation processing by the information processing system 100 according to the first example embodiment.

FIG. 3 is a diagram illustrating the flow of information in the information processing system 100 according to the first example embodiment.

FIG. 4 is a flowchart illustrating a process procedure of the information processing system 100 according to the first example embodiment.

FIG. 5 is a flowchart illustrating a method of extracting a characteristic phrase 208 in the information processing system 100 according to the first example embodiment.

FIG. 6 is a diagram illustrating an outline of message generation processing by an information processing system 100 according to a second example embodiment.

FIG. 7 is a diagram illustrating an outline of message generation processing by an information processing system 100 according to a third example embodiment.

FIG. 8 is a diagram illustrating an example of a configuration of an information processing system 800 according to an example embodiment.

FIG. 9 is a flowchart illustrating a process procedure by the information processing system 800 illustrated in FIG. 8.

FIG. 10 is a schematic block diagram illustrating a configuration of a computer according to at least one example embodiment.

### EXAMPLE EMBODIMENT

Hereinafter, an information processing system, an information processing method, and a program according to each example embodiment will be described with reference to the drawings. In the present specification, “based on XX” means “based on at least XX”, and includes a case of being based on another element in addition to XX. In addition, “based on XX” is not limited to a case where XX is directly used, and includes a case where calculation or processing is performed on XX. “X” is an arbitrary element (for example, information).

### First Example Embodiment

### Configuration of Information Processing System 100

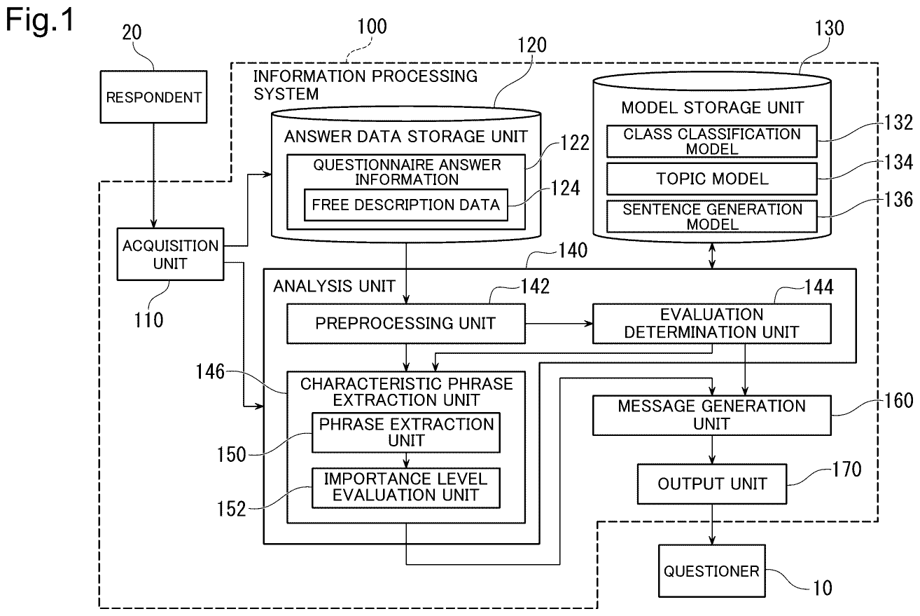

First, a configuration of an information processing system 100 according to a first example embodiment will be described with reference to FIGS. 1 to 3.

FIG. 1 is a block diagram illustrating the information processing system 100 according to the first example embodiment.

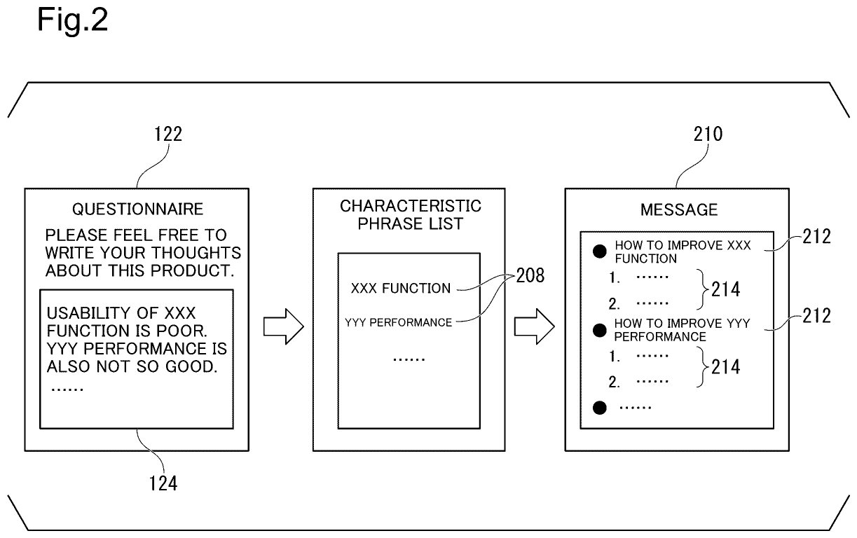

FIG. 2 is a diagram illustrating an outline of message generation processing by the information processing system 100 according to the first example embodiment.

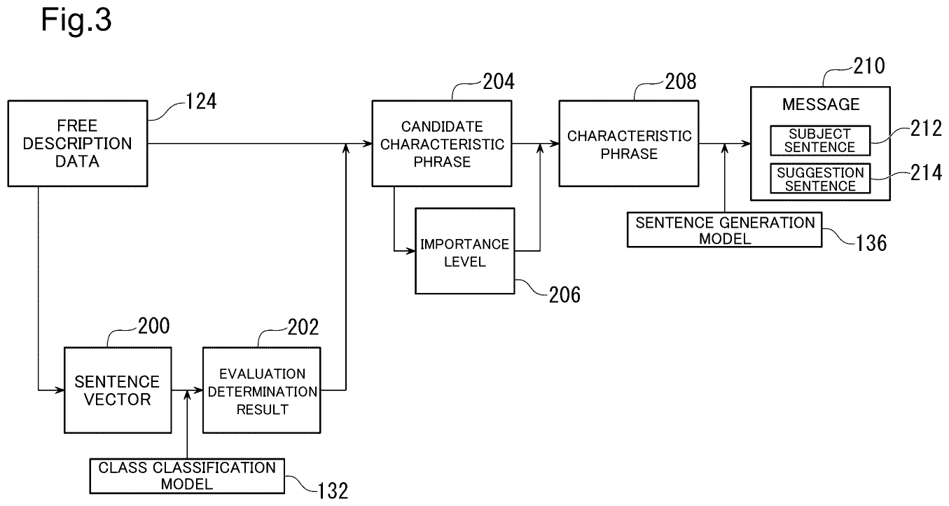

FIG. 3 is a diagram illustrating the flow of information in the information processing system 100 according to the first example embodiment.

The information processing system 100 illustrated in FIG. 1 is a system that processes information of an answer (hereinafter referred to as a “questionnaire answer”) of a respondent 20 to a questionnaire provided by a questioner 10. The questionnaire is for asking for an answer about a specific subject (for example, a product or service of the questioner 10) to be surveyed. The questionnaire answer includes an answer in a free description format. The questionnaire answer may include an answer in a selection form in addition to the answer in the free description form.

The information processing system 100 can be used as, for example, a questionnaire analysis system that aggregates and/or analyzes the questionnaire answer, a classification processing system for online research, or the like.

As illustrated in FIG. 1, the information processing system 100 includes an acquisition unit 110, an answer data storage unit 120, a model storage unit 130, an analysis unit 140, a message generation unit 160, and an output unit 170 as functional units thereof. The information processing system 100 may be a single information processing apparatus (for example, a computer, a tablet terminal, a smartphone, or the like) or a system implemented by cooperation of a plurality of information processing apparatuses. Hereinafter, the information processing system 100 will be described as an independent system, but can provide each function as a program. The information processing system 100 can also be implemented by installing a program in an information processing apparatus such as an operation management terminal, installing a program in an information processing apparatus used by the questioner 10, and/or installing a program in a virtual server on a cloud.

As illustrated in FIG. 2, the information processing system 100 extracts a characteristic phrase 208 from questionnaire answer information 122 including free description data 124 of the respondent 20, and presents a message 210 based on the characteristic phrase 208 to the questioner 10.

The information processing system 100 may individually perform the above-described processing on individual questionnaire answers, or may perform the above-described processing on a set of a plurality of questionnaire answers accumulated. In the former case, characteristic phrases 208 may be extracted from the individual questionnaire answers, and messages 210 may be individually generated. In this case, the characteristic phrases 208 and the messages 210 optimized for individual respondents 20 can be output, which is useful for following the individual respondents 20. On the other hand, in the latter case, characteristic phrases 208 are extracted from the set of questionnaire answers, and a message 210 for the entire set can be generated. In this case, since the characteristic phrases 208 and the message 210 can be output based on the tendency of the entire set of respondents 20, it is beneficial to consider an overall optimal improvement measure.

As illustrated in FIG. 1, the acquisition unit 110 acquires the questionnaire answer information 122 from the respondent 20. The acquisition unit 110 may acquire, as the questionnaire answer information 122, data input to an answer input terminal by the respondent 20, or may acquire, as the questionnaire answer information 122, data obtained by digitalizing, by an optical character reader (OCR) or the like, an answer filled in a questionnaire form by the respondent 20.

The answer data storage unit 120 stores the questionnaire answer information 122. The questionnaire answer information 122 includes the free description data 124. The free description data 124 is preferably text data, but may be another form of data, such as audio data.

The model storage unit 130 stores various models that are used for analysis processing of the information processing system 100. For example, the model storage unit 130 stores analysis models such as a class classification model 132, a topic model 134, and a sentence generation model 136.

The analysis unit 140 analyzes the questionnaire answer information 122. Specifically, the analysis unit 140 includes a preprocessing unit 142, an evaluation determination unit 144, and a characteristic phrase extraction unit 146.

The preprocessing unit 142 (an example of “preprocessing means”) performs necessary preprocessing on the free description data 124 of the questionnaire answer information 122. Specifically, the preprocessing unit 142 executes natural language processing on the free description data 124 to convert the free description answer of the respondent 20 into a computer processable format. For example, the preprocessing unit 142 executes the natural language processing on a text of the free description data 124 to generate a sentence vector 200 of the text as illustrated in FIG. 3. Specifically, the preprocessing unit 142 performs processing such as cleaning processing for removing unnecessary information included in the free description data 124, morphological analysis processing for dividing the free description data 124 into words, normalization processing for unifying notation fluctuations in the free description data 124, and processing for removing a stop word that is not to be processed. As a result, the preprocessing unit 142 converts the free description data 124 into a clean text divided into words. Next, the preprocessing unit 142 executes vectorization processing on the text. Examples of a method for the vectorization include a Bag of Words (BoW) method such as Term Frequency-Inverse Document Frequency (TF-IDF), and distributed representation methods such as Bidirectional Encoder Representations from Transformers (BERT) and Word2Vec.

The evaluation determination unit 144 (an example of “evaluation determination means”) determines what type of evaluation the text of the free description data 124 has for the subject to be surveyed. For example, the evaluation determination unit 144 determines whether the text of the free description data 124 has a negative evaluation of the subject to be surveyed. Specifically, the evaluation determination unit 144 can perform a positive-negative determination to determine whether the text of the free description data 124 has any of a positive evaluation and a negative evaluation (and further a neutral evaluation that may be added) for the subject to be surveyed.

The evaluation determination unit 144 can make the determination using the class classification model 132. The class classification model 132 may be a trained model that has learned the relationship between the sentence vector of the text and the evaluation (for example, any of a positive evaluation, a negative evaluation, and a neutral evaluation) accompanying the text. The sentence vector 200 may be obtained by any method such as TF-IDF, BERT, or Word2Vec. Specifically, the evaluation determination unit 144 reads the class classification model 132 stored in the model storage unit 130, and inputs the sentence vector 200 of the free description data 124 to the class classification model 132. In response to the input of the sentence vector 200 of the text, the class classification model 132 can infer what type of evaluation the text has. As illustrated in FIG. 3, the evaluation determination unit 144 can determine an evaluation of the subject to be surveyed in the free description data 124 as an output of the class classification model 132. As a result, the evaluation determination unit 144 can obtain an evaluation determination result 202.

Learning data of the class classification model 132 is obtained by labeling a plurality of free description texts prepared in advance with evaluation and generating a sentence vector by the natural language processing. The class classification model 132 that has learned the relationship between sentence vectors and evaluations is obtained by learning a large number of sets of the sentence vectors as inputs and evaluation labels as outputs. Any known algorithm such as a support vector machine (SVM), a decision tree, or a neural network can be used as the class classification model 132.

The class classification model 132 may be stored in the model storage unit 130 as a pre-trained model that has performed the learning. In this case, the class classification model 132 is trained by using the learning data prepared in advance before the information processing system 100 is used. Alternatively, the class classification model 132 may perform the learning (for example, in real time) at the time of the evaluation determination by the evaluation determination unit 144. In this case, a user (for example, the questioner 10) labels, with evaluation, the text of the accumulated questionnaire answer, and can train the class classification model 132 using a set of the sentence vector of the labeled text and label information thereof as the learning data.

Note that the determination processing by the evaluation determination unit 144 is not limited to the above-described processing. For example, the evaluation determination unit 144 may perform determination processing on a rule basis without using a machine learning model. Specifically, the evaluation determination unit 144 may use an evaluation determination dictionary created in advance. The evaluation determination dictionary is a phrase list including a plurality of phrases and evaluation labels, such as a positive evaluation and a negative evaluation, given to each phrase. In this case, the evaluation determination unit 144 reads the evaluation determination dictionary, refers to the evaluation determination dictionary, and calculates a ratio of the number of appearances of a positive phrase (positive word, positive phrase) and a ratio of the number of appearances of a negative phrase (negative word, negative phrase) in the free description data 124. The evaluation determination unit 144 uses the calculated ratios of the number of appearances of the positive phrase to the number of appearances of the negative phrase as a weight to determine what type of evaluation the text of the free description data 124 has.

Alternatively, the evaluation determination unit 144 may perform determination processing based on an answer in a selection format included in the questionnaire answer information 122. For example, the questionnaire may include a selective question (for example, a question “Please let us know how you feel about using this product.” and options such as “very satisfied”, “reasonably satisfied”, “normal”, “not very satisfied”, and “very dissatisfied”) asking an evaluation of the subject to be surveyed and a free description question (“Please freely answer the reason for the above selection.”) asking about the reason for the evaluation. In this case, the evaluation determination unit 144 can determine the evaluation by the respondent 20 based on the answer to the selective question. In a case where the evaluation determination unit 144 performs the determination processing based on the text in the free description format, analysis can be performed only based on the free description data 124, which is preferable in that redundancy of the questionnaire can be suppressed. On the other hand, in a case where the determination processing is performed using the answer to the selective question, it is preferable from the viewpoint of improving the reliability of the determination processing and reducing the burden of calculation processing.

The characteristic phrase extraction unit 146 (an example of “characteristic phrase extraction means”) extracts one or more characteristic phrases (hereinafter referred to as a “characteristic phrase”) indicating the content of the questionnaire answer from the text obtained by the preprocessing on the free description data 124. In this case, each of the one or more “phrases” is a concept including one word and a synonym, a phrase, or a clause including two or more words. For example, “air conditioner”, “high fuel efficiency”, “insufficient cooling performance”, “noisy sound”, and the like all correspond to the phrases.

The characteristic phrase extraction unit 146 includes a phrase extraction unit 150 and an importance level evaluation unit 152.

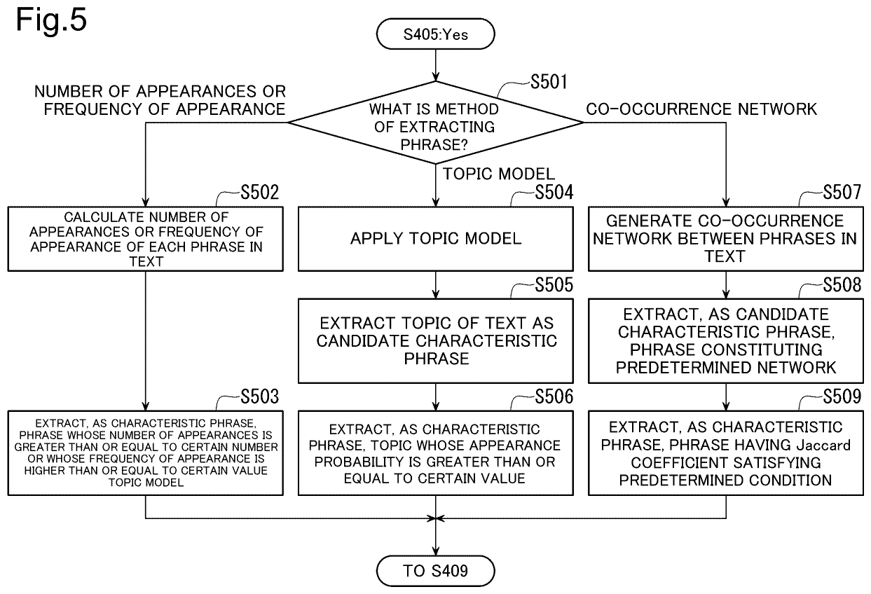

As illustrated in FIG. 3, the phrase extraction unit 150 extracts one or more phrases from the free description data 124 as a candidate characteristic phrase 204. Specifically, the phrase extraction unit 150 extracts the candidate characteristic phrase 204 using a method with the number of appearances or the frequency of appearance of a phrase in the text of the free description data 124, the topic model 134 stored in the model storage unit 130, or a co-occurrence network generated from the text of the free description data 124. Details of each of these methods will be described later with reference to FIG. 5. Note that the processing of the phrase extraction unit 150 is not limited thereto, and any other method can be used.

The importance level evaluation unit 152 (an example of “importance level evaluation means”) weights the candidate characteristic phrase 204 extracted by the phrase extraction unit 150, and calculates an importance level 206 of each candidate characteristic phrase 204. As illustrated in FIG. 3, the characteristic phrase extraction unit 146 extracts one or more characteristic phrases 208 from the candidate characteristic phrase 204 based on the result (that is, the importance level 206) of the weighting by the importance level evaluation unit 152.

In this manner, the characteristic phrase extraction unit 146 can extract the characteristic phrase 208 by extracting the candidate characteristic phrase 204 and evaluating the importance level 206 of each candidate characteristic phrase 204. Alternatively, the characteristic phrase extraction unit 146 may directly extract the characteristic phrase 208 without calculating the importance level 206.

The characteristic phrase extraction unit 146 can extract the characteristic phrase 208 in a case where the text of the free description data 124 is related to a negative evaluation of the subject to be surveyed. Specifically, in a case where the evaluation determination unit 144 determines that the text of the free description data 124 has a negative evaluation of the subject to be surveyed, the characteristic phrase extraction unit 146 generates the characteristic phrase 208 from the text determined to have the negative evaluation. Conversely, in a case where the evaluation determination result 202 by the evaluation determination unit 144 is other than the negative evaluation, the characteristic phrase extraction unit 146 may not extract the characteristic phrase 208. As a result, the information processing system 100 can exclude, a subject to be analyzed, a questionnaire answer that does not indicate a need for improvement from the subject to be analyzed, so that a processing load can be reduced.

The message generation unit 160 (an example of “message means”) generates the message 210 based on the result of the analysis by the analysis unit 140. The message 210 generated by the message generation unit 160 is, for example, a specific message 210 based on the content of the questionnaire answer. The message 210 includes, for example, a suggestion sentence 214 for reducing or eliminating the negative evaluation by the respondent 20. Specifically, the message generation unit 160 can generate the message 210 including a suggestion for improving a matter indicated by the characteristic phrase 208 extracted by the characteristic phrase extraction unit 146.

For example, as illustrated in FIG. 2, the message generation unit 160 can generate a subject sentence 212 and a suggestion sentence 214 to the questioner 10. The message generation unit 160 generates, for a characteristic phrase A having a high importance level 206, the subject sentence 212 such as “how to improve the characteristic phrase A” or “Please improve the characteristic phrase A”. Further, the message generation unit 160 generates the suggestion sentence 214 for the one or more characteristic phrases 208 extracted by the characteristic phrase extraction unit 146. The one or more characteristic phrases 208 targeted for message generation may be the characteristic phrase A included in the subject sentence 212, may be another characteristic phrase 208, or may be both of them. The message generation unit 160 can generate the message 210 including the suggestion sentence 214 using a sentence generation algorithm. Specifically, the message generation unit 160 reads the sentence generation model 136 stored in the model storage unit 130, and generates the suggestion sentence 214 for the characteristic phrase 208 using the sentence generation model 136. The suggestion sentence 214 includes a specific improvement method related to the characteristic phrase 208 for the questioner 10. The message 210 includes the subject sentence 212 and the suggestion sentence 214 generated as described above. Note that the message 210 may include only one of the subject sentence 212 and the suggestion sentence 214.

Examples of the sentence generation algorithm used for the sentence generation model 136 include, but are not limited to, transformer models such as BERT and Generative Pre-trained Transformer 3 (GPT-3), and any algorithm can be used as the sentence generation algorithm. The sentence generation model 136 can generate a natural sentence by learning a large amount of text in advance.

The message generation unit 160 may generate the suggestion sentence 214 by inputting the generated subject sentence 212 such as “How to improve the characteristic phrase A” or “Please improve the feature phrase A” to the sentence generation model 136. Further, the message generation unit 160 may input the characteristic phrase 208 in combination with another phrase to the sentence generation model 136. The other phrase is, for example, a preset phrase (a phrase regarding the subject to be surveyed in the questionnaire, a phrase related to the premise of the question, or the like), a phrase determined from the answer to the selective question, or the like.

The message generation unit 160 can generate the message 210 in a case where the text of the free description data 124 has a negative evaluation of the subject to be surveyed. Specifically, in a case where the evaluation determination unit 144 determines that the text of the free description data 124 has a negative evaluation of the subject to be surveyed, the message generation unit 160 generates the message 210 including a suggestion for reducing or eliminating the negative evaluation. Conversely, in a case where the evaluation determination result 202 by the evaluation determination unit 144 is other than a negative evaluation, the message generation unit 160 may not generate the message 210.

The message generation unit 160 converts the generated message 210 into a message 210 in an output format and transmits the converted message 210 to the output unit 170. The output unit 170 (an example of “message means”) outputs the message 210 generated by the message generation unit 160 and presents the message 210 to the questioner 10. A method of presenting the message 210 is not particularly limited, and the message 210 may be presented as a text, or may be presented in a format other than a text, such as an image or a voice.

In a case where the information processing system 100 is constituted by a single information processing apparatus, the information processing apparatus can independently extract the characteristic phrase 208 and generate and output the message 210. In a case where the information processing system 100 is implemented by cooperation of a plurality of information processing apparatuses, distributed processing of the above-described functions may be performed in various forms. For example, a first information processing apparatus can extract the characteristic phrase 208 and transmit information of the extracted characteristic phrase 208 to a second information processing apparatus, and the second information processing apparatus can generate the message 210 related to the characteristic phrase 208. The presentation of the message 210 to the user may be executed by any of the first information processing apparatus, the second information processing apparatus, and another information processing apparatus or a presentation apparatus. The first information processing apparatus that has extracted the characteristic phrase 208 can present the message 210 to the user by using a configuration of the first information processing apparatus (for example, an output interface of the first information processing apparatus, such as a display or a speaker) or another apparatus (for example, the second information processing apparatus, the other information processing apparatus, or the presentation apparatus).

### Process Procedure of Information Processing System 100

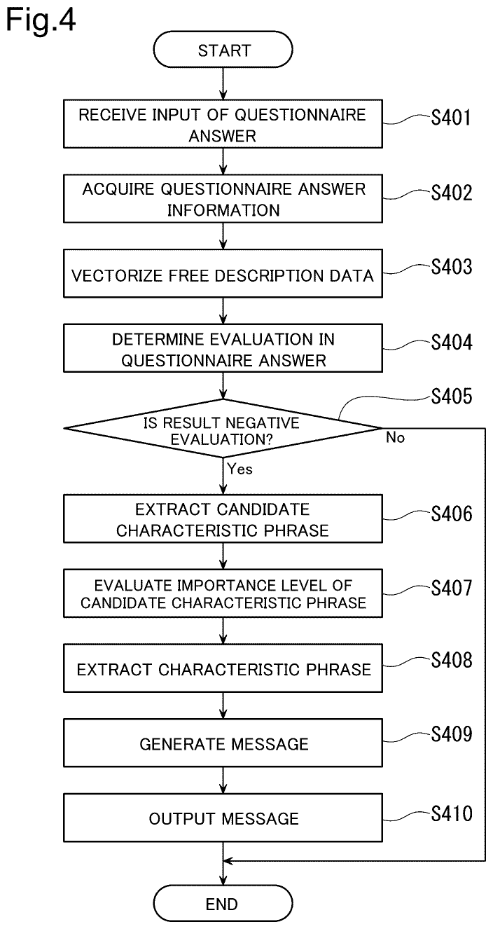

Next, an information processing method by the information processing system 100 will be described with reference to FIGS. 4 and 5.

FIG. 4 is a flowchart illustrating a process procedure of the information processing system 100 according to the first example embodiment.

FIG. 5 is a flowchart illustrating a method of extracting a characteristic phrase 208 in the information processing system 100 according to the first example embodiment.

The information processing method by the information processing system 100 includes: extracting one or more characteristic phrases 208 related to a negative evaluation of the subject to be surveyed from a text that is included in a questionnaire answer and is in a free description format regarding the subject to be surveyed; and presenting a message 210 related to the extracted one or more characteristic phrases 208.

The process procedure of the information processing system 100 will be described below in detail. As illustrated in FIG. 4, first, in step S401, the information processing system 100 receives an input of answer data by the respondent 20. In step S402, the acquisition unit 110 acquires the input questionnaire answer information 122. In step S403, the preprocessing unit 142 preprocesses the free description data 124 included in the questionnaire answer information 122 to generate the sentence vector 200 of the free description data 124. In step S404, the evaluation determination unit 144 determines an evaluation by the respondent 20 for the subject to be surveyed, by using the sentence vector generated by the preprocessing unit 142. In a case where the evaluation determination result 202 is not a negative evaluation (step S405: No), the information processing system 100 ends the process. In a case where the evaluation determination result 202 is a negative evaluation (step S405: Yes), the phrase extraction unit 150 extracts the candidate characteristic phrase 204 from the free description data 124 in step S406. In step S407, the importance level evaluation unit 152 weights each candidate characteristic phrase 204 and calculates an importance level 206. In step S408, the characteristic phrase extraction unit 146 extracts a characteristic phrase 208 from the candidate characteristic phrase 204 based on the importance level 206. In step S409, the message generation unit 160 generates a message 210 regarding the extracted characteristic phrase 208. In step S410, the output unit 170 outputs the message 210.

Next, with reference to FIG. 5, a method for the extraction of the candidate characteristic phrase 204, the evaluation of the importance level 206, and the extraction of the characteristic phrase 208 will be described in detail. As described above, the characteristic phrase extraction unit 146 can use the following characteristic phrase extraction methods (a) to (c).
(a) The method using the number of appearances or the frequency of appearance of a phrase in the text of the free description data 124
(b) The method using the topic model 134 stored in the model storage unit 130
(c) The method using the co-occurrence network generated from the text of the free description data 124

In the method (a) (step S501: the number of appearances or the frequency of appearance), the characteristic phrase extraction unit 146 can extract the characteristic phrase 208 based on the number of appearances or the frequency of appearance of each phrase in the text of the free description data 124.

Specifically, in step S502, the characteristic phrase extraction unit 146 calculates the number of appearances or the frequency of appearance of each phrase included in the text of the free description data 124. Next, in step S503, the characteristic phrase extraction unit 146 extracts, as the characteristic phrase 208, a phrase whose number of appearances is large or whose frequency of appearance is high. For example, the characteristic phrase extraction unit 146 extracts, as the characteristic phrase 208, a phrase whose number of appearances is greater than a predetermined threshold or whose frequency of appearance is higher than a predetermined threshold. In this case, the characteristic phrase extraction unit 146 directly extracts the characteristic phrase 208 from the free description data 124 without extracting the candidate characteristic phrase 204 and calculating the importance level 206. In other words, the characteristic phrase extraction unit 146 extracts the weighted phrase from the free description data 124. Note that the characteristic phrase extraction unit 146 may extract the characteristic phrase 208 using an arbitrary function depending on the number of appearances or the frequency of appearance, instead of using the number of appearances or the frequency of appearance.

The characteristic phrase extraction unit 146 may first extract the candidate characteristic phrase 204, then calculate the importance level 206, and extract the characteristic phrase 208 based on the importance level 206. In this case, first, the phrase extraction unit 150 calculates the number of appearances or the frequency of appearance of each phrase. The phrase extraction unit 150 extracts, as the candidate characteristic phrase 204, a phrase whose number of appearances is large or whose frequency of appearance is high. Next, the importance level evaluation unit 152 weights the candidate characteristic phrase 204 based on the number of appearances or the frequency of appearance calculated by the phrase extraction unit 150 or a function of the number of appearances or the frequency of appearance. For example, the importance level evaluation unit 152 calculates (the number of appearances of a specific phrase/(the total number of words of a document) as a function of the number of appearances. The characteristic phrase extraction unit 146 can use, as the importance level 206, the number of appearances of the phrase, the frequency of appearance of the phrase, or the value of the function of the number of appearances or the frequency of appearance. The characteristic phrase extraction unit 146 extracts, as the characteristic phrase 208, a phrase (for example, a phrase greater than a predetermined threshold) whose number of appearances is large or whose frequency of appearance is high or a phrase having the value of the function of the number of appearances or the frequency of appearance is large.

In the method (b) (step S501: the topic model), the phrase extraction unit 150 can extract the candidate characteristic phrase 204 using the topic model 134. The topic model is a method of analyzing a potential meaning of the entire document based on a type and frequency of appearance of words in the document.

Specifically, in step S504, the phrase extraction unit 150 determines a topic (subject) of the text of the free description data 124 using the topic model 134 stored in the model storage unit 130. In step S505, the phrase extraction unit 150 can extract, as the candidate characteristic phrase 204, a topic having a high appearance probability in the text.

In step S506, the importance level evaluation unit 152 weights the candidate characteristic phrase 204 based on the appearance probability of each topic in the text. For example, the importance level evaluation unit 152 can use the appearance probability of each topic output from the topic model 134 or a function thereof as the importance level 206. The characteristic phrase extraction unit 146 extracts a topic (for example, a topic greater than a predetermined threshold) having a high appearance probability as the characteristic phrase 208.

In the method (c) (step S501: the co-occurrence network), the phrase extraction unit 150 can extract the candidate characteristic phrase 204 based on the co-occurrence network generated from the free description data 124. By using the co-occurrence network, relationships between phrases appearing in a sentence can be determined. As a result, it is possible to visualize which phrase is emphasized and which phrase the phrase frequently appears together with.

Specifically, in step S507, the phrase extraction unit 150 generates the co-occurrence network between the phrases included in the text of the free description data 124. In step S508, the phrase extraction unit 150 extracts, as the candidate characteristic phrase 204, a phrase constituting a predetermined network in the co-occurrence network. For example, the phrase extraction unit 150 extracts, as the candidate characteristic phrase 204, a phrase constituting a network with a preset target phrase.

In step S509, the importance level evaluation unit 152 weights the candidate characteristic phrase based on a value of a Jaccard coefficient. The Jaccard coefficient is a value indicating the percentage of a sentence including both of a phrase A and a phrase B among sentences including at least one of the phrase A and the phrase B. The Jaccard coefficient is an index indicating the strength of co-occurrence (that is, relevance between phrases), and is large for phrases that appear in many sentences, and is small for phrases whose frequencies of appearance are low. For example, the importance level evaluation unit 152 calculates the Jaccard coefficient between a phrase to be evaluated and the preset target phrase. The characteristic phrase extraction unit 146 extracts a phrase having a large Jaccard coefficient (for example, a phrase greater than the predetermined threshold) as the characteristic phrase 208.

The characteristic phrase extraction unit 146 may use two or more of the above-described methods (a) to (c) in combination. Alternatively, one or more of the above-described methods (a) to (c) and another method may be used in combination. By extracting the characteristic phrase 208 by a plurality of methods, it is possible to provide a degree of freedom in the selection of the characteristic phrase 208. In the method (a), the characteristic phrase extraction unit 146 can select the characteristic phrase 208 regardless of the relevance between the phrases, whereas in the method (c), the characteristic phrase extraction unit 146 selects the characteristic phrase 208 based on the relevance between the phrases. In the method (b), the characteristic phrase extraction unit 146 can extract a phrase (topic) other than the phrases included in the text of the free description data 124 as the characteristic phrase 208.

### Effects

According to the information processing system 100 according to the present example embodiment, it is possible to extract the characteristic phrase 208 from the questionnaire answer in the free description format and present the message 210 based on the extracted characteristic phrase 208. As a result, in presenting the message 210 based on the questionnaire answer in the free description format, the content of the original questionnaire answer can be accurately reflected in the message 210. In addition, since it is not always necessary to set a category for classifying the questionnaire answer in the free description format in advance as in PTL 1, the efficiency of creating the questionnaire can be improved. Furthermore, since the arbitrariness of the analysis that may occur when the category is set in advance can be reduced, a more objective message 210 can be obtained.

The information processing system 100 according to the present example embodiment can automatically extract the characteristic phrase 208. Therefore, the efficiency of the analysis of the questionnaire answer can be remarkably improved as compared with the case of manually extracting an important phrase. In addition, since personal and subjective variations in phrase extraction are eliminated, the accuracy of the analysis can be improved. As a result, even in a case where a point emphasized by the respondent 20 is a matter that cannot be predicted by the questioner 10, the point can be extracted as the characteristic phrase 208, and the appropriate message 210 can be output.

Furthermore, examples of problems in a case where the questionnaire answer in the free description format is directly input to the sentence generation model and the message 210 is output include the following.
(1) In a case where a complicated and difficult questionnaire answer is input, there is a possibility that an appropriate message 210 cannot be generated.
(2) In a case where a complicated and difficult questionnaire answer is input, there is a possibility that inappropriate learning data is input to the sentence generation model.
(3) In a case where a sentence generation model stored in an external server is used, a questionnaire answer result is directly transmitted to the external server, which may cause a security problem.

On the other hand, the information processing system 100 according to the present example embodiment extracts the characteristic phrase 208 from the questionnaire answer in the free description format, and then outputs the message 210 based on the extracted characteristic phrase 208. Therefore, the above-described problems (1) to (3) can be reduced or solved.

Meanwhile, in general, in a case where a specific phrase rather than the entire text is input to the sentence generation model 136, there is a possibility that the context of the original text cannot be sufficiently read. In addition, when the processing of extracting the characteristic phrase 208 is interposed, there is a possibility that the calculation load increases by the processing of extracting the characteristic phrase 208 as compared with the case of simply inputting the text to the sentence generation model 136. However, in the present example embodiment, the subject to be analyzed is the simple questionnaire answer, and a precondition in the free description answer can be sufficiently grasped in advance, so that there is little need to read the context from the text. Rather, it may be difficult to read a context only from a text of a questionnaire answer in a short sentence. Therefore, in the analysis of the questionnaire answer, it may be effective to temporarily extract the characteristic phrase 208 from the text without directly inputting the text to the sentence generation model 136.

The information processing system 100 according to the present example embodiment can present a message including a suggestion for reducing or eliminating a negative evaluation. As a result, the next action based on the questionnaire answer can be clarified. Therefore, it is possible to reduce the burden on the questioner 10 to consider improvement measures as compared with a case where the characteristic phrase 208 is simply presented as the summary of the questionnaire answer.

The information processing system 100 according to the present example embodiment includes the preprocessing unit 142 that generates the sentence vector of the text by performing the natural language processing on the text of the questionnaire answer. By setting the sentence vector as a target to be subjected to calculation processing, the amount of data can be reduced and the calculation processing can be sped up as compared with the case of handling the text itself.

The information processing system 100 according to the present example embodiment includes the importance level evaluation unit 152 that extracts the weighted characteristic phrase from the text of the questionnaire answer or weights the phrase extracted from the text. As a result, the information processing system 100 automatically evaluates the importance level 206 of the phrase, so that manual weighting can be omitted. In addition, as with the characteristic phrase extraction described above, personal and subjective variations in the phrase weighting are eliminated, so that the accuracy of the analysis can be improved.

The information processing system 100 according to the present example embodiment includes the evaluation determination unit 144 that determines what type of evaluation the text of the questionnaire answer has for the subject to be surveyed using the questionnaire. As a result, the information processing system 100 can significantly improve the efficiency of the analysis of the questionnaire answer as compared with the case of manually determining whether the questionnaire answer has a positive evaluation or a negative evaluation. In addition, as with the characteristic phrase extraction and weighting described above, personal and subjective variations in the evaluation determination are eliminated, so that the accuracy of analysis can be improved.

### Second Example Embodiment

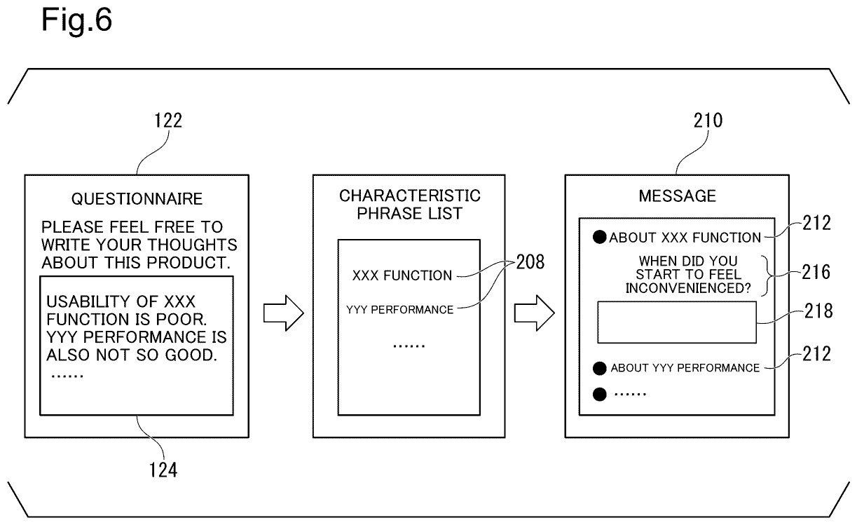

An information processing system 100 according to a second example embodiment will be described with reference to FIG. 6. The second example embodiment is different from the first example embodiment in that a message 210 including a question sentence 216 to the respondent 20 is output. Differences from the above-described example embodiment will be mainly described, and description of points common to the above-described example embodiment will not be repeated.

FIG. 6 is a diagram illustrating an outline of message generation processing by the information processing system 100 according to the second example embodiment.

The information processing system 100 according to the second example embodiment can exchange information with the respondent 20 in real time. Specifically, as illustrated in FIG. 6, the information processing system 100 extracts a characteristic phrase 208 from questionnaire answer information 122 input by the respondent 20, and generates the message 210 including the question sentence 216 from the characteristic phrase 208. Therefore, the information processing system 100 can generate the message 210 including the question sentence 216 in real time and present the message 210 to the respondent 20 in response to input of a questionnaire answer by the respondent 20. The information processing system 100 can display an answer form 218 together with the message 210 to request the respondent 20 to further answer the question sentence 216.

Specifically, the message generation unit 160 generates the additional question sentence 216 based on the characteristic phrase 208 extracted in the same manner as in the first example embodiment. For example, in a case where a characteristic phrase 208 of “cooling performance of the air conditioner” is extracted from free description data 124 with a negative evaluation, the message generation unit 160 generates a question sentence 216 necessary for improving the satisfaction level of the respondent 20 for “cooling performance of the air conditioner”. Examples of a question in this case include the timing when the respondent 20 felt dissatisfied with the cooling performance, the use environment of the air conditioner, the number of years of use of the air conditioner, the maintenance status of the air conditioner, a request of the respondent 20 to the questioner 10, and the like.

In addition to the question sentence 216 or instead of the question sentence 216, the message generation unit 160 may generate an arbitrary message 210 such as an explanatory sentence (for example, a description of a method of using a product or a maintenance method) about the subject to be surveyed, a suggestion sentence (for example, a suggestion sentence of a repair service or maintenance service) to the respondent 20, or an apology to the respondent 20. Further, the message generation unit 160 may generate a suggestion sentence 214 to the questioner 10 as in the first example embodiment in addition to the message 210 such as the question sentence 216 to the respondent 20.

In a case where the evaluation determination unit 144 determines that a text of the free description data 124 has a negative evaluation of the subject to be surveyed, the message generation unit 160 generates the message 210 including the additional question sentence 216 for the subject to be surveyed. On the other hand, in a case where an evaluation determination result 202 by the evaluation determination unit 144 is other than a negative evaluation, the message generation unit 160 does not need to generate the message 210 including the question sentence 216.

According to the information processing system 100 according to the second example embodiment, the message 210 includes the question sentence 216 to the respondent 20. As a result, the information processing system 100 can additionally ask the respondent 20 a question in real time according to an answer of the respondent 20. Therefore, it is possible not only to ask a common question but also to flexibly ask various questions according to a specific answer of the respondent 20. As a result, it is possible to acquire a detailed questionnaire answer including a specific circumstance of the respondent 20.

### Third Example Embodiment

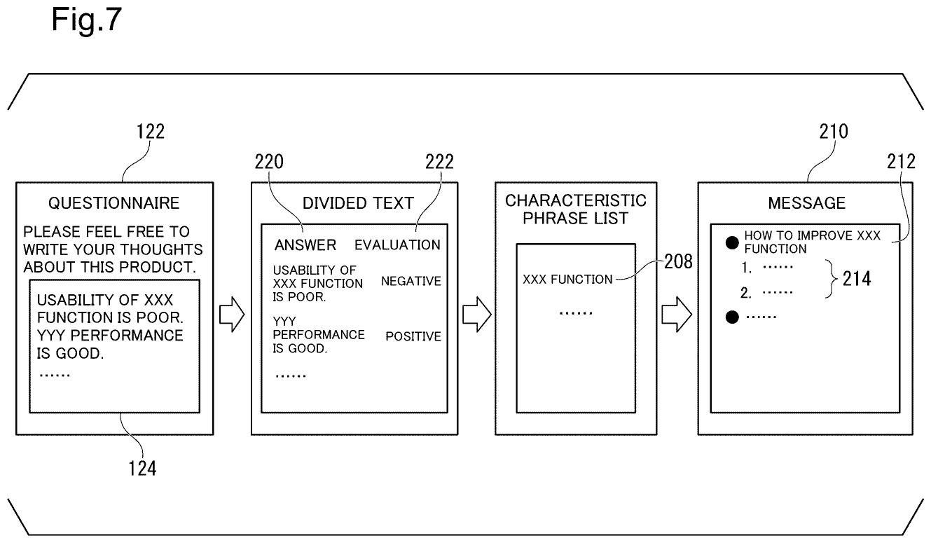

An information processing system 100 according to a third example embodiment will be described with reference to FIG. 7. The third example embodiment is different from the first example embodiment in that evaluation determination by the evaluation determination unit 144 is executed in a phrase unit and/or a divided text unit instead of or in addition to the evaluation determination on the entire text of the free description data 124. Differences from the above-described example embodiment will be mainly described, and description of points common to the above-described example embodiment will not be repeated.

FIG. 7 is a diagram illustrating an outline of message generation processing by the information processing system 100 according to the third example embodiment.

The information processing system 100 according to the third example embodiment executes the evaluation determination in a word/phrase unit or a divided text unit. Specifically, as illustrated in FIG. 7, before the evaluation determination by the evaluation determination unit 144, the preprocessing unit 142 divides the text of the free description data 124 into several texts. The unit of division is not particularly limited, and the text may be mechanically divided into sentence units, section units, phrase units, or the like, or may be divided into meaningful groups. As a method of dividing the text, any method can be used. Next, the evaluation determination unit 144 executes the evaluation determination for each divided text. In the example illustrated in FIG. 7, a sentence “The usability of the XXX function is poor.” is determined to have a negative evaluation, while a sentence “YYY performance is good.” is determined to have a positive evaluation. Next, the characteristic phrase extraction unit 146 extracts a characteristic phrase 208 from a phrase included in the divided text determined to have a negative evaluation. The characteristic phrase extraction unit 146 may not extract, as the characteristic phrase 208, a phrase included only in the divided text and not determined to have a negative evaluation.

As a result, phrases extracted as characteristic phrases 208 are all phrases extracted from the divided text with a negative evaluation. That is, the extracted characteristic phrases 208 are all phrases with a negative evaluation. In other words, in the third example embodiment, it can be said that evaluation determination is performed on the phrases included in the text. The characteristic phrase extraction unit 146 can extract one or more characteristic phrases 208 from the phrases determined by the evaluation determination unit 144 to have the negative evaluation of the subject to be surveyed.

Note that the method of performing the evaluation determination on the phrases included in the text is not limited to the method of performing the evaluation determination on the divided text, and any method can be used. For example, the evaluation determination may be performed directly on each phrase, or a phrase highly relevant to a preset negative phrase may be extracted using a co-occurrence network or the like (in this case, the evaluation determination of the text is not necessarily required.).

According to the information processing system 100 according to the third example embodiment, evaluation determination processing can be executed on a part of a text of a questionnaire answer (for example, for the divided text or one or more phrases included in the text,). Therefore, the information processing system 100 can more appropriately extract a characteristic phrase 208 related to a negative evaluation as compared with a case where the evaluation determination processing is performed only on the entire text. As a result, it is possible to present a message 210 such as an improvement suggestion that more accurately reflects the content of the questionnaire answer.

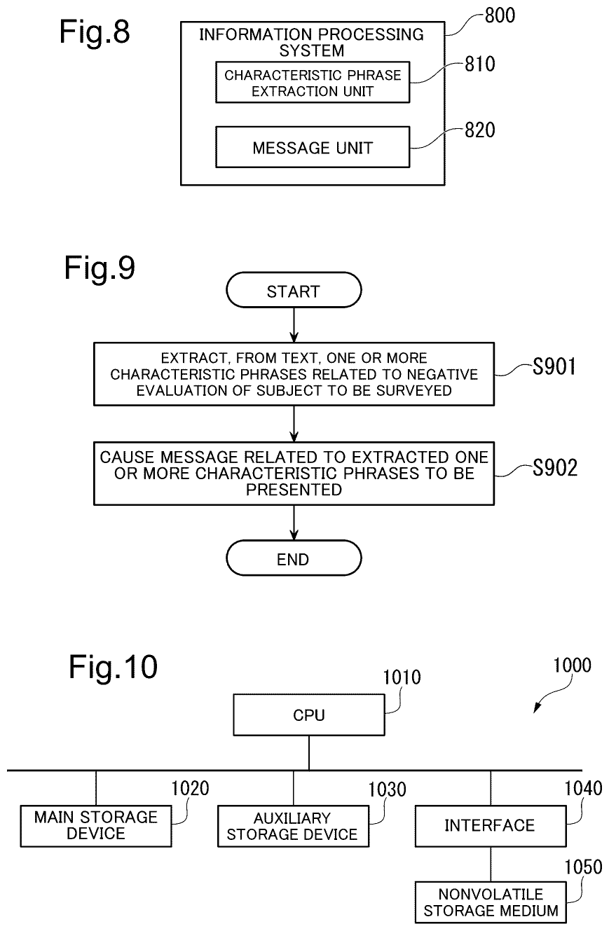

FIG. 8 is a diagram illustrating an example of a configuration of an information processing system 800 according to an example embodiment.

FIG. 9 is a flowchart illustrating a process procedure by the information processing system 800 illustrated in FIG. 8.

The information processing system 100 may include at least configurations of a characteristic phrase extraction unit 810 and a message unit 820.

This information processing system 100 processes information of a questionnaire answer including a text in a free description format regarding the subject to be surveyed.

The characteristic phrase extraction unit 810 extracts, from the text, one or more characteristic phrases related to a negative evaluation of the subject to be surveyed (step S901).

The message unit 820 presents a message related to the extracted one or more characteristic phrases (step S902).

FIG. 10 is a schematic block diagram illustrating a configuration of a computer according to at least one example embodiment.

In the configuration illustrated in FIG. 10, a computer 1000 includes a CPU 1010, a main storage device 1020, an auxiliary storage device 1030, an interface 1040, and a nonvolatile recording medium 1050.

All or a part of the information processing system 100 may be implemented in the computer 1000. In this case, the operation of each processing unit described above is stored in the auxiliary storage device 1030 in the form of a program.

The CPU 1010 reads the program from the auxiliary storage device 1030, develops the program in the main storage device 1020, and executes the above-described processing in accordance with the program. In addition, the CPU 1010 secures a storage area corresponding to each of the above-described storage units in the main storage device 1020 in accordance with the program. Communication between each apparatus and another apparatus is executed by the interface 1040 having a communication function and performing communication under control by the CPU 1010. In addition, the interface 1040 has a port for the nonvolatile recording medium 1050, and reads information from the nonvolatile recording medium 1050 and writes information to the nonvolatile recording medium 1050.

In a case where the information processing system 100 is implemented in the computer 1000, the operations of the analysis unit 140, the message generation unit 160, and each unit thereof are stored in the auxiliary storage device 1030 in the form of a program. The CPU 1010 reads the program from the auxiliary storage device 1030, develops the program in the main storage device 1020, and executes the above-described processing in accordance with the program.

The CPU 1010 secures, in the main storage device 1020, a storage area for the answer data storage unit 120 and the model storage unit 130 in accordance with the program. Communication with another apparatus is executed by the interface 1040 having a communication function and operating under control by the CPU 1010. The display of the message 210 by the output unit 170 is executed by the interface 1040 including a display device and displaying an image including the message 210 under control by the CPU 1010. The interaction between the information processing system 100 and the user is executed by the interface 1040 including input and output devices such as a display device, a controller, a mouse, and a keyboard and operating under control by the CPU 1010.

Any one or more of the above-described programs may be recorded in the nonvolatile recording medium 1050. In this case, the interface 1040 may read the program from the nonvolatile recording medium 1050. The CPU 1010 may directly execute the program read by the interface 1040 or may temporarily store the program in the main storage device 1020 or the auxiliary storage device 1030 and execute the program.

Note that a program for executing all or part of the processing performed by the information processing system 100 and the computer 1000 may be recorded in a computer-readable recording medium, and the processing of each unit may be performed by causing a computer system to read and execute the program recorded in the recording medium. The “computer system” herein includes an operating system (OS) and hardware such as a peripheral device. The “computer-readable recording medium” refers to a portable medium such as a flexible disk, a magneto-optical disk, a read only memory (ROM), a compact disc read only memory (CD-ROM), or a storage device such as a hard disk built in the computer system. In addition, the program may be for implementing some of the functions described above, and the functions described above may be implemented in combination with the program already recorded in the computer system.

In each of the above-described example embodiments, each unit constituting the information processing system 100 has been described as a software functional unit, but may be a hardware functional unit such as an LSI.

Although the example embodiments of the present disclosure have been described above, the example embodiments are described as examples and are not intended to limit the scope of the present disclosure. This example embodiment can be implemented in various other forms, and various omissions, substitutions, and changes can be made without departing from the gist of the present disclosure.

Some or all of the above-described example embodiments may be described as the following supplementary notes, but are not limited to the following.

### Supplementary Note 1

An information processing system that processes information of a questionnaire answer including a text in a free description format regarding a subject to be surveyed, the information processing system including:
characteristic phrase extraction means for extracting, from the text, one or more characteristic phrases related to a negative evaluation of the subject to be surveyed; and
message means for presenting a message related to the extracted one or more characteristic phrases.

### Supplementary Note 2

The information processing system according to Supplementary Note 1, wherein
the message includes one or more selected from the group of:
(1) a suggestion for reducing or eliminating the negative evaluation,
(2) a description regarding the subject to be surveyed;
(3) an apology for the subject to be surveyed; and
(4) a question about the subject to be surveyed.

### Supplementary Note 3

The information processing system according to Supplementary Note 1 or 2, wherein
the characteristic phrase extraction means extracts the one or more characteristic phrases from the text by using one or more of a number of appearances of a phrase in the text, a frequency of appearance of the phrase in the text, a topic model, and a co-occurrence network generated from the text.

### Supplementary Note 4

The information processing system according to Supplementary Note 3, wherein
the characteristic phrase extraction means extracts, as a characteristic phrase, a phrase whose number of appearances is large or whose frequency of appearance is high in the text.

### Supplementary Note 5

The information processing system according to any one of Supplementary Notes 1 to 4, further including
importance level evaluation means for extracting a weighted phrase from the text or weighting a phrase extracted from the text.

### Supplementary Note 6

The information processing system according to Supplementary Note 5, wherein
the characteristic phrase extraction means extracts the one or more characteristic phrases based on a result of the weighting by the importance level evaluation means.

### Supplementary Note 7

The information processing system according to Supplementary Note 5 or 6, wherein
the characteristic phrase extraction means extracts, as a candidate characteristic phrase, a phrase whose number of appearances is large or whose frequency of appearance is high in the text, and
the importance level evaluation means weights the candidate characteristic phrase based on the number of appearances or the frequency of appearance in the text or a function of the number of appearances or the frequency of appearance.

### Supplementary Note 8

The information processing system according to Supplementary Note 5 or 6, wherein
the characteristic phrase extraction means extracts a topic of the text as a candidate characteristic phrase by using a topic model, and
the importance level evaluation means weights the candidate characteristic phrase based on an appearance probability of each topic in the text.

### Supplementary Note 9

The information processing system according to Supplementary Note 5 or 6, wherein
the characteristic phrase extraction means extracts, as a candidate characteristic phrase, a phrase constituting a predetermined network in a co-occurrence network between phrases generated from the text, and
the importance level evaluation means weights the candidate characteristic phrase based on a value of a Jaccard coefficient.

### Supplementary Note 10

The information processing system according to any one of Supplementary Notes 1 to 9, further including
evaluation determination means for determining what type of evaluation the text has for the subject to be surveyed.

### Supplementary Note 11

The information processing system according to Supplementary Note 10, wherein
the evaluation determination means determines whether the text has a negative evaluation of the subject to be surveyed.

### Supplementary Note 12

The information processing system according to Supplementary Note 10 or 11, wherein
the evaluation determination means performs the determination using a trained model that has learned a relationship between a sentence vector of the text and an evaluation accompanying the text.

### Supplementary Note 13

The information processing system according to any one of Supplementary Notes 10 to 12, wherein
the characteristic phrase extraction means extracts the one or more characteristic phrases from the text in a case where the evaluation determination means determines that the text is related to a negative evaluation of the subject to be surveyed.

### Supplementary Note 14

The information processing system according to any one of Supplementary Notes 10 to 13, wherein
the evaluation determination means determines whether one or more phrases included in the text have a negative evaluation of the subject to be surveyed.

### Supplementary Note 15

Information processing system according to Supplementary Note 14, wherein
the characteristic phrase extraction means extracts the one or more characteristic phrases from one or more phrases determined by the evaluation determination means to have a negative evaluation of the subject to be surveyed.

### Supplementary Note 16

The information processing system according to any one of Supplementary Notes 10 to 15, wherein
in a case where the evaluation determination means determines that the text has a negative evaluation of the subject to be surveyed, the message means causes a message including a suggestion for reducing or eliminating the negative evaluation to be presented.

### Supplementary Note 17

The information processing system according to any one of Supplementary Notes 10 to 16, wherein
in a case where the evaluation determination means determines that the text has a negative evaluation of the subject to be surveyed, the message means causes a message including a question about the subject to be surveyed to be presented to a respondent of a questionnaire.

### Supplementary Note 18

The information processing system according to any one of Supplementary Notes 1 to 17, wherein
the message means causes a message including a suggestion for improving a matter indicated by the one or more characteristic phrases to be presented.

### Supplementary Note 19

The information processing system according to any one of Supplementary Notes 1 to 18, wherein
the message means includes message generation means for generating the message using a sentence generation algorithm.

### Supplementary Note 20

The information processing system according to any one of Supplementary Notes 1 to 19, further including
preprocessing means for generating a sentence vector of the text by performing natural language processing on the text.

### Supplementary Note 21

The information processing system according to any one of Supplementary Notes 1 to 20, wherein
the message means causes the message to be presented based on an individual questionnaire answer.

### Supplementary Note 22

The information processing system according to any one of Supplementary Notes 1 to 20, wherein
the message means presents the message based on a set of a plurality of questionnaire answers.

### Supplementary Note 23

An information processing method executed by a computer, the method including:
extracting, from a text that is included in a questionnaire answer and is in a free description format regarding a subject to be surveyed, one or more characteristic phrases related to a negative evaluation of the subject to be surveyed; and
presenting a message related to the extracted one or more characteristic phrases.

### Supplementary Note 24

A recording medium storing a program for causing a computer to execute:
extracting, from a text that is included in a questionnaire answer and is in a free description format regarding a subject to be surveyed, one or more characteristic phrases related to a negative evaluation of the subject to be surveyed; and
presenting a message related to the extracted one or more characteristic phrases.

This application is based upon and claims the benefit of priority from Japanese patent application No. 2023-040780, filed on Mar. 15, 2023, the disclosure of which is incorporated herein in its entirety by reference.

### INDUSTRIAL APPLICABILITY

The present disclosure may be applied to an information processing system, an information processing method, and a recording medium.

### REFERENCE SIGNS LIST

100 information processing system
110 acquisition unit
120 answer data storage unit
130 model storage unit
140 analysis unit
142 preprocessing unit
144 evaluation determination unit
146 characteristic phrase extraction unit
150 phrase extraction unit
152 importance level evaluation unit
160 message generation unit
170 output unit

What is claimed is:

1. An information processing system that processes information of a questionnaire answer including a text in a free description format regarding a subject to be surveyed, the information processing system comprising:
one or more memories storing instructions; and
one or more processors configured to execute the instructions to:
extract, from the text, one or more characteristic phrases related to a negative evaluation of the subject to be surveyed; and
present a message related to the extracted one or more characteristic phrases.

2. The information processing system according to claim 1, wherein the message includes one or more selected from the group of:
(1) a suggestion for reducing or eliminating the negative evaluation,
(2) a description regarding the subject to be surveyed;
(3) an apology for the subject to be surveyed; and
(4) a question about the subject to be surveyed.

3. The information processing system according to claim 1, wherein
the one or more processors are configured to execute the instructions to extract the one or more characteristic phrases from the text by using one or more of a number of appearances of a phrase in the text, a frequency of appearance of the phrase in the text, a topic model, and a co-occurrence network generated from the text.

4. The information processing system according to claim 3, wherein the one or more processors are configured to execute the instructions to extract, as a characteristic phrase, a phrase whose number of appearances is large or whose frequency of appearance is high in the text.

5. The information processing system according to claim 1
wherein the one or more processors are further configured to execute the instructions to:
extract a weighted phrase from the text or weight a phrase extracted from the text; and
extract the one or more characteristic phrases based on a result of the weighting.

6. The information processing system according to claim 5, wherein
the one or more processors are configured to execute the instructions to:
extract, as a candidate characteristic phrase, a phrase whose number of appearances is large or whose frequency of appearance is high in the text; and
weight the candidate characteristic phrase based on the number of appearances or the frequency of appearance in the text or a function of the number of appearances or the frequency of appearance.

7. The information processing system according to claim 5, wherein
the one or more processors are configured to execute the instructions to:
extract a topic of the text as a candidate characteristic phrase by using a topic model, and
weight the candidate characteristic phrase based on an appearance probability of each topic in the text.

8. The information processing system according to claim 5, wherein
the one or more processors are configured to execute the instructions to:
extract, as a candidate characteristic phrase, a phrase constituting a predetermined network in a co-occurrence network between phrases generated from the text; and
weight the candidate characteristic phrase based on a value of a Jaccard coefficient.

9. The information processing system according to claim 1,
wherein the one or more processors are further configured to execute the instructions to determine what type of evaluation the text has for the subject to be surveyed.

10. The information processing system according to claim 9, wherein
the one or more processors are configured to execute the instructions to determine whether the text has a negative evaluation of the subject to be surveyed.

11. The information processing system according to claim 9, wherein
the one or more processors are configured to execute the instructions to perform the determination using a trained model that has learned a relationship between a sentence vector of the text and an evaluation accompanying the text.

12. The information processing system according to claim 9, wherein
the one or more processors are configured to execute the instructions to extract the one or more characteristic phrases from the text in a case where the one or more processors determine that the text is related to a negative evaluation of the subject to be surveyed.

13. The information processing system according to claim 9, wherein
the one or more processors are configured to execute the instructions to determine whether one or more phrases included in the text have a negative evaluation of the subject to be surveyed.

14. The information processing system according to claim 13, wherein
the one or more processors are configured to execute the instructions to extract the one or more characteristic phrases from one or more phrases determined to have a negative evaluation of the subject to be surveyed.

15. The information processing system according to claim 9, wherein
in a case where the one or more processors determine that the text has a negative evaluation of the subject to be surveyed, the one or more processors cause a message including a suggestion for reducing or eliminating the negative evaluation to be presented.

16. The information processing system according to claim 9, wherein
in a case where the one or more processors determine that the text has a negative evaluation of the subject to be surveyed, the one or more processors cause a message including a question about the subject to be surveyed to be presented to a respondent of a questionnaire.

17. The information processing system according to claim 1, wherein
the one or more processors are configured to execute the instructions to cause a message including a suggestion for improving a matter indicated by the one or more characteristic phrases to be presented.

18. The information processing system according to claim 1, wherein
the one or more processors are configured to execute the instructions to generate the message using a sentence generation algorithm.

19. An information processing method executed by a computer, the method comprising:
extracting, from a text that is included in a questionnaire answer and is in a free description format regarding a subject to be surveyed, one or more characteristic phrases related to a negative evaluation of the subject to be surveyed; and
presenting a message related to the extracted one or more characteristic phrases.

20. A non-transitory recording medium storing a program for causing a computer to execute:
extracting, from a text that is included in a questionnaire answer and is in a free description format regarding a subject to be surveyed, one or more characteristic phrases related to a negative evaluation of the subject to be surveyed; and
presenting a message related to the extracted one or more characteristic phrases.
